(19) United States
(12) Patent Application Publication
(10) Pub. No.: US 2013/0275025 A1
(43) Pub. Date: Oct. 17, 2013

(54) SYSTEM AND METHOD FOR CONTROLLING A HEATED FUEL INJECTOR IN AN INTERNAL COMBUSTION ENGINE

(71) Applicants: JOHN K. ISENBERG, ROSSVILLE, IN (US); DANIEL F. KABASIN, ROCHESTER, NY (US)

(72) Inventors: JOHN K. ISENBERG, ROSSVILLE, IN (US); DANIEL F. KABASIN, ROCHESTER, NY (US)

(73) Assignee: DELPHI TECHNOLOGIES, INC., Troy, MI (US)

(21) Appl. No.: 13/444,320

(22) Filed: Apr. 11, 2012

(51) Int. Cl. F02D 41/30

(52) U.S. Cl. 701/103

(57) ABSTRACT

A system, a controller, and a method for controlling a fuel injector during start-up of a fuel injected internal combustion engine. The fuel injector has a heater element configured to heat liquid fuel, such as gasoline, ethanol, gasoline/alcohol blends, diesel, or JP-8 within the fuel injector and indicate heater temperature. The controller is configured to estimate a fuel temperature based on the heater temperature, determine a crankshaft angle at which to initiate an injection event based on the fuel temperature, and initiate the injection event at the determined crankshaft angle. The controller is further configured to determine injection duration based on the fuel temperature and operate the fuel injector according to the determined injection duration. The controller may delay the injection event until the fuel temperature reaches a fuel temperature threshold. The injection event may be a priming injection event, cranking injection event, or running injection event.

### TECHNICAL FIELD OF INVENTION

The invention generally relates to an internal combustion engine with a heated fuel injector, and more particularly relates to controlling fuel injection timing and fuel injection duration during engine start-up.

### BACKGROUND OF INVENTION

Fuel-injected spark-ignited internal combustion engines fueled by liquid fuels, such as gasoline, alcohols (e.g. methanol, ethanol, or butanol), or gasoline/alcohol blends (e.g. E-10, E-85) are well known. Internal combustion engines typically produce power by controllably combusting a compressed fuel/air mixture in a combustion chamber. In a spark ignited engine fueled by gasoline, ignition of the fuel/air mixture readily occurs except at extremely low temperatures (i.e. below −40° C.) because of the relatively low flash point of gasoline. (The term “flash point” of a fuel is defined herein as the lowest temperature at which the fuel can form an ignitable mixture in air). However, in a spark ignited engine fueled by alcohol-based fuels such as ethanol (E-100), or mixtures of ethanol and gasoline (e.g. E-85) having a much higher flash point, ignition of the fuel/air charge may not occur in cooler climate conditions. For example, ethanol has a flashpoint of about 12.8° C. Thus, starting a spark-ignited engine fueled by ethanol can be difficult or impossible under cold ambient temperature conditions experienced seasonally in many parts of the world.

Therefore, in many geographic areas, it is highly desirable to provide some means for enhancing the cold starting capabilities of such spark-ignited engines fueled by ethanol or other alcohol-based fuels. There are currently several approaches to aid cold starting of such engines. For example, some engines are equipped with an auxiliary gasoline injection system for injecting gasoline into the fuel/air charge that is utilized under cold start conditions. The use of such auxiliary system adds undesirable cost to the vehicle and to the operation of the vehicle and may increase the maintenance cost required for the engine due to deposits building up in the infrequently used auxiliary gasoline injection system. Another approach to aid cold starting of spark-ignited engines fueled by ethanol or other blends of alcohol is to pre-heat the fuel in the fuel injector before being ignited in the combustion chamber.

At 20° C., a minimum of approximately 1% gasoline or 4% ethanol vapor concentration in air must be present in the vicinity of a spark plug to produce a combustible mixture. Current practice to produce these required vapor percentages is to inject additional liquid fuel during engine start-up. As used herein, engine start-up is the time period from an initial or priming injection event until the engine speed reaches a predetermined engine speed threshold, usually an engine idle speed typically between 600 and 1000 revolutions per minute (RPM). During engine start-up, the priming injection event is typically the first injection event. The priming injection event delivers a quantity of fuel, not only to fire the engine, but to also provide a “reservoir” of fuel within an intake manifold by wetting down the interior surfaces of the intake manifold with excess fuel, sufficient to produce a flawless cranking-to-running transition without any engine stumbling or hesitation. The priming injection event is typically a single injection event. The priming injection duration is usually much longer than subsequent injection events. A series of cranking injection events follows the priming injection during engine start up. The cranking injection duration is longer than typical running injection duration to provide a richer air/fuel mixture during engine start-up.

For example, at an ambient temperature of 20° C. gasoline that has a nominal 14.7:1 stoichiometric Air-Fuel Ratio (A/F) during running conditions, is enriched to approximately 8:1 A/F during engine start-up, modulating to approximately 12:1 A/F for the initial run. Similarly, at an ambient temperature of 20° C. ethanol's nominal 9:1 stoichiometric A/F is enriched to approximately 2:1 A/F for engine start-up and approximately 8:1 A/F during the initial running period. However, enriched A/F mixtures during engine start-up, especially when occurring before catalytic converter light-off temperatures have been achieved, increase both hydrocarbon (HC) and carbon monoxide (CO) tailpipe emissions.

However, with lower volatility liquid fuels, such as E-100, enriching the A/F ratio at a lower ambient temperature, for example −5° C. for E-100 fuel, does not increase the fuel vapor concentration to the 6% vapor required to support combustion for E-100 fuel at −5° C. because the fuel will remain in the liquid state since it is below the fuel's flash point. This may cause serious problems in cold starting conditions ranging from failure to start to engine damage due to fuel dilution of the lubricating oil.

### SUMMARY OF THE INVENTION

In accordance with one embodiment of this invention, a system configured to control a fuel-injected internal combustion engine during engine start-up is provided. The system includes a heated fuel injector and a controller that is configured to estimate a fuel temperature of the fuel within the fuel injector based on a fuel heater temperature, determine a crankshaft angle to initiate a priming injection event based on the fuel temperature, and initiate the priming injection event at the determined crankshaft angle.

In another embodiment of the present invention, a controller configured to operate a heated fuel injector is provided. The controller is configured to estimate a fuel temperature of the fuel within the fuel injector based on a fuel heater temperature, determine a crankshaft angle to initiate a priming injection event based on the fuel temperature, and initiate the priming injection event at the determined crankshaft angle.

In yet another embodiment of the present invention, a method of controlling a fuel injector during start-up of a fuel injected internal combustion engine is provided. The fuel injector has a heater element configured to heat fuel within the fuel injector and indicate heater temperature. The method includes the steps of estimating a fuel temperature of the fuel within the fuel injector based on a fuel heater temperature, determining a crankshaft angle to initiate a priming injection event based on the fuel temperature, and initiating the priming injection event at the determined crankshaft angle.

In yet another embodiment of the present invention, the method of controlling a fuel injector during engine start-up may further include the steps of determining if the fuel temperature exceeds a priming temperature threshold and delaying the priming injection event until the fuel temperature exceeds the priming temperature threshold.

In yet another embodiment of the present invention, the method of controlling a fuel injector during engine start-up may further include the step of delaying the priming injection event until the fuel temperature exceeds the priming temperature threshold for a predetermined time interval.

In yet another embodiment of the present invention, the method of controlling a fuel injector during engine start-up may further include the steps of determining a priming injection duration based on the fuel temperature and operating the fuel injector for the priming injection duration.

In yet another embodiment of the present invention, the method of controlling a fuel injector during engine start-up may further include the steps of determining a subsequent heater temperature after a preceding injection event, estimating a subsequent fuel temperature of the fuel within the fuel injector based on the subsequent heater temperature, determining a subsequent crankshaft angle to initiate a subsequent injection event based on the subsequent fuel temperature, and initiating the subsequent injection event at the determined subsequent crankshaft angle.

In yet another embodiment of the present invention, the method of controlling a fuel injector during engine start-up may further include the steps of determining if the subsequent fuel temperature exceeds a subsequent injection event temperature threshold and delaying the subsequent injection event until the subsequent fuel temperature exceeds the subsequent injection event temperature threshold.

In yet another embodiment of the present invention, the subsequent injection event may be a cranking injection event.

In yet another embodiment of the present invention, the subsequent injection event may be a running injection event.

In yet another embodiment of the present invention, the step of estimating the fuel temperature or the step of estimating the subsequent fuel temperature of the method of controlling a fuel injector during engine start-up may include determining at least one engine operating parameter other than the fuel heater temperature, wherein the at least one engine operating parameter is selected from a group consisting of manifold air temperature, fuel mass rate, heater element activation start time, and heater element activation elapsed time.

In yet another embodiment of the present invention, the method of controlling a fuel injector during engine start-up may further include the steps of determining a subsequent injection duration based on the subsequent fuel temperature and operating the fuel injector for the subsequent injection duration.

In yet another embodiment of the present invention, the subsequent injection duration may be based at least one engine operating parameter other than the fuel heater temperature, wherein the at least one engine operating parameter is selected from a group consisting of system voltage, ambient temperature, engine temperature, and cranking duration.

Further features and advantages of the invention will appear more clearly on a reading of the following detailed description of the preferred embodiment of the invention, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a schematic diagram of a vehicle equipped with a system configured to control a fuel-injected internal combustion engine during engine start-up in accordance with one embodiment;

FIG. 2 is flow diagram of a method for controlling a heated fuel injector in accordance with another embodiment; and

FIG. 3 is flow diagram of a method for controlling a heated fuel injector in accordance with another embodiment.

### DETAILED DESCRIPTION OF INVENTION

Heating a liquid fuel, especially a lower volatility fuel such as ethanol or other alcohol-based fuels, using a heated fuel injector may provide sufficient fuel vapor to support combustion for engine start-up in low ambient temperature conditions, for example with E-100 fuel when ambient temperatures are less than 18° C. A heated fuel injector may also enable a leaner air to fuel ratio (A/F) during engine start-up, which may reduce undesirable engine emissions during engine start-up. While the description is directed mainly toward alcohol-based fuels, this system and method may be applied for controlling a heating fuel injector used with any liquid fuel, such as gasoline, diesel fuel, or JP-8.

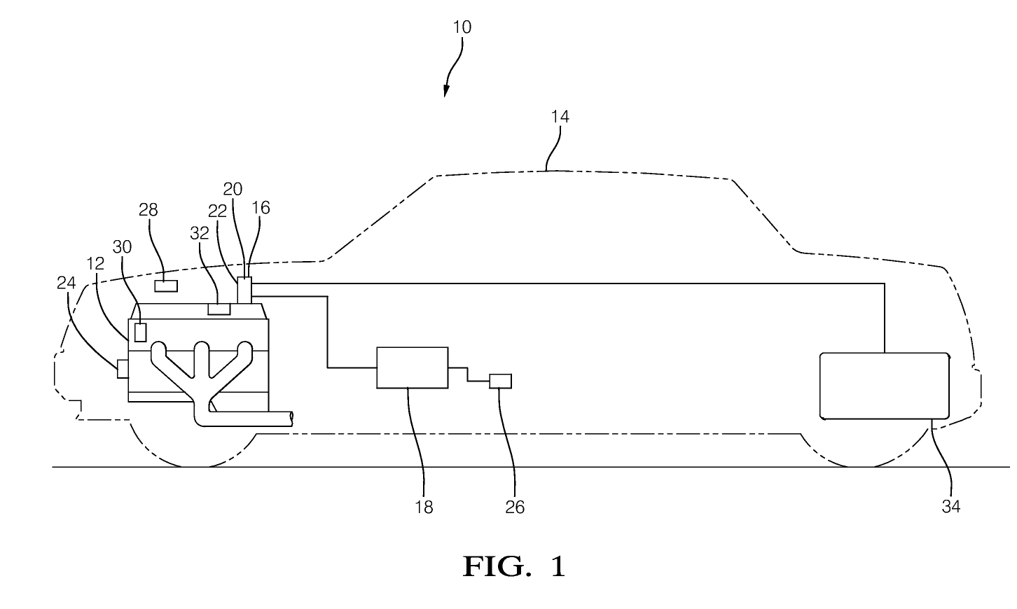

FIG. 1 illustrates a non-limiting example of a system 10 that is configured to control a fuel-injected internal combustion engine 12 during engine start-up. The engine 12 may be installed in a vehicle 14. The system 10 includes a heated fuel injector 16 and a controller 18. The heated fuel injector 16 includes an injector heater element 20. The injector heater element 20 may be disposed within the heated fuel injector 16. A non-limiting example of such a heated fuel injector is shown in U.S. Patent Application Publication 2010/0078507 A1, the entire contents of which is hereby incorporated by reference herein. The heated fuel injector 16 also includes an integral temperature sensing element 22 that is configured to determine a temperature of the injector heater element 20. In a non-limiting example, the integral temperature sensing element 22 may be a temperature dependent electrical device such as a thermistor or it may be the injector heater element 20 itself. A non-limiting example of such an integral temperature sensing element is shown in U.S. Patent Application Publication 2011/0276252 A1, the entire contents of which is hereby incorporated by reference herein.

The controller 18 is configured to control injection events and injection duration of the heated fuel injector 16. As used herein, an injection event is the initiation of introduction of fuel into the intake manifold or combustion chamber by the heated fuel injector 16, typically when sufficient electrical power is applied to a solenoid operated valve within the heated fuel injector 16 to open the valve. The injection event will generally determine the point at which fuel is introduced to the engine during each combustion cycle. As used herein, injection duration is the length of time that a valve within the fuel injector is open and injecting fuel that is under pressure into the intake manifold or combustion chamber. The injection duration generally determines how much fuel is injected into the engine by the heated fuel injector 16 during each combustion cycle. The controller 18 is also configured to control the activation of the injector heater element 20 within the heated fuel injector 16. The engine 12 may include a plurality of heated fuel injectors 16. The controller 18 may control each heated fuel injector in the plurality of fuel injectors separately. Alternatively, the controller 18 may exercise common control of the plurality of heated fuel injectors 16. The plurality of heated fuel injectors may also be divided into several banks including multiple heated fuel injectors and each bank of heated fuel injectors may be commonly controlled by the controller 18.

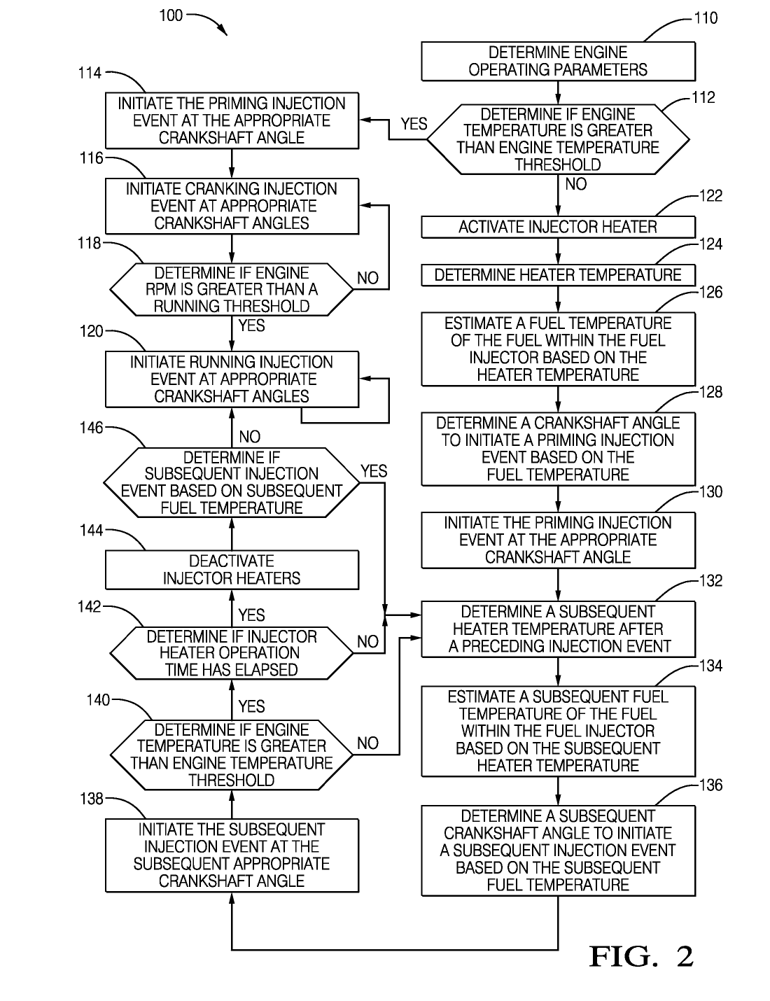

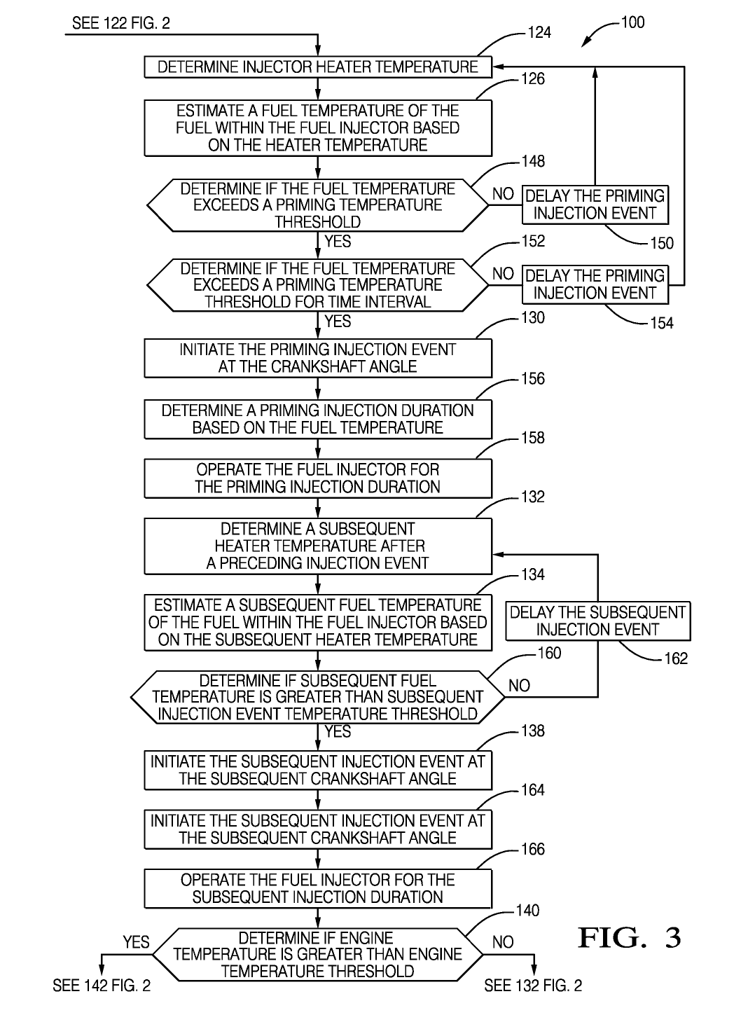

The controller 18 may include a microprocessor or application specific integrated circuit (ASIC) configured to control the heated fuel injector 16 and injector heater element 20. Software that configures the microprocessor or ASIC to control the heated fuel injector 16 according to the method 100 shown in FIGS. 2 and 3 and described infra may be stored in non-volatile (NV) memory within the controller 18. Non-limiting examples of the types of NV memory that may be used include electrically erasable programmable read only memory (EEPROM), masked read only memory (ROM) and flash memory. The controller 18 may also include analog to digital (A/D) convertor circuits and digital to analog (D/A) convertor circuits to allow the convertor to establish electrical communication with devices outside the controller 18, such as sensors. The controller 18 may also include power supply circuitry. The controller 18 may be integrated with an engine controller system that controls other engine functions, such as spark timing. These integrated engine controllers are commonly referred to as an engine control module (ECM). The design and construction methods of heated fuel injectors 16 and controllers 18 are well known to those skilled in the art.

The controller 18 may be in electrical communication with various vehicle sensors. In a non-limiting example, the controller 18 may be in communication with a crankshaft angle sensor 24. Data from the crankshaft angle sensor 24 may be used by the controller 18 to determine the crankshaft angle used to determine a priming injection event or a subsequent injection event. The controller 18 may use the crankshaft angle data to determine timing of an intake valve opening, since valve opening is typically controlled by a camshaft mechanically coupled between the valve and the crankshaft. Engine valve timing based on crankshaft angle is well known to those skilled in the art.

The controller 18 is also in communication with the integral temperature sensing element 22 within the heated fuel injector 16 to determine a fuel temperature based on the heater element temperature. As a non-limiting example, the integral temperature sensing element may be a temperature sensor, such as a thermistor, or the integral temperature sensing element may be the injector heater element 20 itself. The determination of fuel temperature may additionally be based upon engine parameters beyond the heater element temperature including, but not limited to, ambient air temperature, engine temperature, intake manifold air temperature, and fuel mass rate.

The controller 18 may additionally be in electrical communication with sensors in the vehicle 14 that are configured to provide data to the controller 18 including, but not limited to, an electrical system voltage sensor 26, an ambient air temperature sensor 28, an engine temperature sensor 30 (e.g. engine coolant sensor), the integral temperature sensing element 22, and an intake manifold air temperature sensor 32. The sensors and the methods used to determine engine parameters are well known to those skilled in the art. The controller 18 may also be configured to determine heater element activation start time, heater element activation elapsed time, and engine cranking duration by measuring the time of these events. Fuel may be stored in a fuel tank 34 disposed within the vehicle 14.

The controller 18 may be configured to activate the injector heater element 20 when the engine temperature determined by the engine temperature sensor 30 is below an engine temperature threshold, for example 18° C. for E-100 fuel, and turn the heater element off when the engine temperature exceeds the engine temperature threshold. Alternatively, the controller 18 may activate the injector heater element 20 when engine start-up begins and deactivate the injector heater element 20 after the expiration of a predetermined time period, for example 20 seconds.

The controller 18 is configured to estimate a fuel temperature of the fuel within the heated fuel injector 16 based on the heater temperature of the injector heater element 20, determine a crankshaft angle based on the estimated fuel temperature, and initiate the priming injection event at the determined crankshaft angle based on the output of the crankshaft angle sensor 24.

FIG. 2 illustrates a non-limiting example of a method 100 of controlling a heated fuel injector 16 during start-up of a fuel injected internal combustion engine. The heated fuel injector 16 is equipped with an injector heater element 20 that is configured to heat the fuel within the heated fuel injector 16 and may also be equipped with an integral temperature sensing element 22 capable of indicating a heater temperature. The heated fuel injector 16 may be controlled by a controller 18 as shown in FIG. 1 that is configured to execute the steps of method 100.

Step 110, DETERMINE ENGINE OPERATING PARAMETERS may include determining the values of various engine operating parameters including, but not limited to, crankshaft angle, injector heater temperature, electrical system voltage, ambient air temperature, engine temperature, intake manifold air temperature, and fuel mass rate. These parameters may be determined by the controller 18 from inputs provided by the electrical system voltage sensor 26, the ambient air temperature sensor 28, the engine temperature sensor 30, the integral temperature sensing element 22, and the intake manifold air temperature sensor 32. The fuel mass rate may be calculated by converting the injection duration (in milliseconds) into a fuel mass quantity delivered by the heated fuel injector 16 during each injection event using a flow curve (fuel mass vs. injection duration) of the heated fuel injector 16, and engine speed (RPM). Alternatively, the vehicle may include a fuel flow rate sensor and the fuel mass rate can be determined based on the fuel's density.

The method 100 may further include a step 112, DETERMINE IF ENGINE TEMPERATURE IS GREATER THAN ENGINE TEMPERATURE THRESHOLD. In Step 112 the controller 18 may determine if the engine temperature exceeds an engine temperature threshold, for example 18° C. for E-100 fuel. The engine temperature threshold may be the engine temperature at which the fuel provides a sufficient vapor concentration to support combustion.

If at step 112 the controller 18 determines that the engine temperature exceeds the engine temperature threshold, according to method 100, the controller 18 may proceed to step 114, INITIATE PRIMING INJECTION EVENT AT THE APPROPRIATE CRANKSHAFT ANGLE. At steps 114 through 120, the controller 18 may not activate the injector heater element 20. In steps 114, 116 and 120, injection events are not based on a fuel temperature of the fuel within the heated fuel injector 16. Since the engine temperature is above the engine temperature threshold required to provide adequate vaporization of the fuel, it may not be necessary to heat the fuel or adjust fuel injection timing and duration based on fuel temperature to provide adequate vaporization of the fuel to support combustion.

At step 114, the controller 18 may command the heated fuel injector 16 to begin delivery of a priming injection of fuel to the engine at the appropriate crankshaft angle. Typically, the priming injection event will occur when the crankshaft angle is coincidental to a closed intake valve.

The method 100 may then proceed to step 116, INITIATE CRANKING INJECTION EVENT AT APPROPRIATE CRANKSHAFT ANGLES. At step 116 the controller 18 may initiate a cranking injection event at appropriate crankshaft angles for delivering a cranking injection of fuel to the engine. Typically, the cranking injection event will occur when the crankshaft angle is coincidental to a closed intake valve.

The method 100 may then proceed to step 118, DETERMINE IF ENGINE RPM IS GREATER THAN A RUNNING THRESHOLD. Step 118 may determine if engine speed in revolutions per minute (RPM) is greater than a running threshold; the running threshold typically being between 600 and 1000 RPM. If the engine speed is less than the running threshold, the method 100 may return to step 116, INITIATE CRANKING INJECTION EVENT AT APPROPRIATE CRANKSHAFT ANGLES to continue the engine start-up period.

If the engine speed is greater than the running threshold, the method 100 may continue to step 120, INITIATE RUNNING INJECTION EVENT AT APPROPRIATE CRANKSHAFT ANGLES. At step 120 the controller 18 may initiate a running injection event at appropriate crankshaft angles for delivering a running injection of fuel to the engine. At this point, the engine start-up period has typically ended and the initiation of the running injection events are based mainly on desired engine power output requirements. The controller 18 may continue to loop through step 120 as long as the engine continues to run.

Alternatively, if at step 112, DETERMINE IF ENGINE TEMPERATURE IS GREATER THAN ENGINE TEMPERATURE THRESHOLD, the controller 18 determines that the engine temperature is less than the engine temperature threshold, the method 100 may proceed to step 122, ACTIVATE INJECTOR HEATER. At step 122 the controller 18 may activate the injector heater element 20 by allowing electrical power to be supplied to the injector heater element 20 in order to heat the fuel within the heated fuel injector 16. Step 122 may be initiated at the beginning of engine cranking (activation of the engine's starter motor) or preferably prior to engine cranking.

The method 100 may further include step 124, DETERMINE INJECTOR HEATER TEMPERATURE. At Step 124 the controller 18 may determine injector heater temperature by monitoring a resistance of the injector heater element 20, monitoring the integral temperature sensing element 22, or monitoring the electrical power supplied to the injector heater element 20 as three non-limiting examples. Based upon the injector heater temperature determined at step 124, the controller 18 may control the injector heater temperature by increasing the electrical power supplied to the injector heater element 20 to raise the injector heater temperature, thereby raising the fuel temperature of fuel within the heated fuel injector 16. Alternatively, the controller 18 may decrease the electrical power applied to the injector heater element 20 to lower the injector heater temperature, thereby lowering the fuel temperature of fuel within the heated fuel injector 16. The injector heater temperature should be limited to prevent fuel from overheating and boiling within the heated fuel injector 16 and/or prevent overheating the injector heater element 20 that could damage the heated fuel injector 16.

The method 100 may additionally include step 126, ESTIMATE A FUEL TEMPERATURE OF THE FUEL WITHIN THE FUEL INJECTOR BASED ON THE HEATER TEMPERATURE. At step 126, the controller 18 may estimate a fuel temperature of the fuel within the heated fuel injector 16 based on the heater temperature determined in step 124. The estimation of the fuel temperature may be based on a thermal model of the heated fuel injector 16 programmed within the controller 18. Step 126 may additionally be based on at least one other engine operating parameter other than the heater temperature selected from a group consisting of intake manifold air temperature, fuel mass rate, heater element activation start time, and heater element activation elapsed time. The inclusion of manifold air temperature in the fuel temperature estimation may provide a benefit of accounting for heat loss through the injector tip that is disposed within the intake manifold and may allow the controller 18 to estimate the temperature of the fuel after it is injected into the intake manifold. The inclusion of the fuel mass rate in the fuel temperature estimation may provide the benefit of allowing the controller 18 to account for a difference in heater temperature and fuel temperature at higher fuel mass rates since the time that the fuel will be heated by the injector heater element 20 will decrease. The inclusion of heater element activation start time and heater element activation elapsed time in the fuel temperature estimation may provide the benefit of accounting for the time required for the heated fuel injector 16 to warm up when the injector heater element 20 is activated and cool down when the injector heater element 20 is deactivated.

The method 100 may also include step 128, DETERMINE A CRANKSHAFT ANGLE TO INITIATE A PRIMING INJECTION EVENT BASED ON THE FUEL TEMPERATURE. At Step 128 the controller 18 may determine a crankshaft angle to initiate a priming injection event based on the fuel temperature determined in step 126. Typically, the priming injection event occurs at a crankshaft angle when the intake value is closed. At step 128, the controller 18 may determine a crankshaft angle so that the priming injection event occurs just before or just as the intake valve begins to open for the intake stroke or at some optimal crankshaft angle for gasoline direct injection or diesel engines. Initiating the priming injection event at this point of the combustion cycle may reduce the amount of fuel that condenses on the interior surfaces of the intake manifold. Therefore, the amount of fuel injected into the intake manifold by the priming injection may be reduced and still supply a sufficient amount of vaporized fuel to support combustion to the combustion chamber.

The method 100 may further include step 130, INITIATE THE PRIMING INJECTION EVENT AT THE APPROPRIATE CRANKSHAFT ANGLE. At Step 130 the controller 18 may initiate the priming injection event at the appropriate crankshaft angle determined in step 128. This may provide the advantage that the injected fuel will be in contact with a cold intake manifold for a shorter period of time before the intake valve opens, therefore less of the injected fuel may condense on the interior surfaces of the intake manifold. Similarly, in direct injection applications where fuel is injected directly into the combustion chamber (e.g. diesel, gasoline direct injection (GDI)), less of the injected fuel may condense on the surfaces of the combustion chamber. This may improve engine start-up performance and emissions in cold start conditions (e.g. ambient temperature less than 18° C. for E-100 fuel) because less fuel may need to be injected during the priming injection duration in order to provide a sufficient quantity of vaporized fuel to support combustion and wet the interior surfaces of the intake manifold sufficiently to produce a flawless crank-to-run transition without any engine stumbling or hesitation.

The method 100 may additionally include step 132, DETERMINE A SUBSEQUENT HEATER TEMPERATURE AFTER A PRECEDING INJECTION EVENT. At Step 132 the controller 18 may determine a subsequent heater temperature after a preceding injection event. At Step 132 the controller 18 may determine injector heater temperature again, by monitoring the resistance of the injector heater element 20, monitoring the integral temperature sensing element 22, or monitoring the electrical power supplied to the injector heater element 20, as three non-limiting examples, since determining the heater temperature for the preceding injection event. Based upon the injector heater temperature determined at step 132, the controller 18 may control the injector heater temperature by increasing the electrical power supplied to the injector heater element 20 to raise the injector heater temperature, thereby raising the fuel temperature of fuel within the heated fuel injector 16. Alternatively, the controller 18 may decrease the electrical power applied to the injector heater element 20 to lower the injector heater temperature, thereby lowering the fuel temperature of fuel within the heated fuel injector 16.

The injection event preceding step 132 may be a priming injection event, a cranking injection event, or a running injection event. The subsequent heater temperature may need to be determined because the heater temperature may have changed since the preceding injection event due to factors such as an increase in the temperature of the heated fuel injector 16 due to heater activation duration or a decrease in the temperature of the heated fuel injector 16 due to increased fuel mass flow though the heated fuel injector 16.

The method 100 may also include step 134, ESTIMATE A SUBSEQUENT FUEL TEMPERATURE OF THE FUEL WITHIN THE FUEL INJECTOR BASED ON THE SUBSEQUENT HEATER TEMPERATURE. At step 134 the controller 18 may estimate a subsequent fuel temperature of the fuel within the heated fuel injector 16 based on the subsequent heater temperature determined in step 132. Step 134 may additionally be based on determining at least one other engine operating parameter other than the subsequent heater temperature selected from a group consisting of intake manifold air temperature, fuel mass rate, heater element activation start time, and heater element activation elapsed time. The advantages of determining at least one other engine parameter in step 134 are the same as the advantages listed for step 120 supra. The subsequent injection event of step 134 may be a cranking injection event or a running injection event.

The method 100 may further include step 136, DETERMINE A SUBSEQUENT CRANKSHAFT ANGLE TO INITIATE A SUBSEQUENT INJECTION EVENT BASED ON THE SUBSEQUENT FUEL TEMPERATURE. At Step 136 the controller 18 may determine a subsequent crankshaft angle to initiate a subsequent injection event based on the subsequent fuel temperature determined in step 134. Typically, a cranking injection event occurs at a crankshaft angle when the intake value is closed. At step 136, the controller 18 may determine a crankshaft angle so that the subsequent injection occurs just before the intake valve begins to open or when the intake valve is open for the intake stroke. This may provide a benefit of reducing the time for the fuel in the subsequent injection event to condense on the interior surfaces of the intake manifold (e.g. port injection) or combustion chamber (e.g. direct injection). The subsequent injection event of step 136 may be a cranking injection event or a running injection event. It may be beneficial to continue to determine a subsequent crankshaft angle to initiate a running injection event based on the subsequent fuel temperature after the engine speed has exceeded the engine speed threshold until the engine temperature exceeds the engine temperature threshold (see FIG. 2, step 140). This may provide the benefit of providing sufficient fuel vapor to support combustion in cold start conditions (e.g. ambient temperature less than 18° C. for E-100 fuel) and requiring less fuel during the initial run period when the A/F ratio is typically slightly enriched because fuel will have less time to condense on the interior surfaces of the intake manifold or combustion chamber.

The method 100 may also include step 138, INITIATE THE SUBSEQUENT INJECTION EVENT AT THE SUBSEQUENT APPROPRIATE CRANKSHAFT ANGLE. At Step 138 the controller 18 may initiate the subsequent injection event at the subsequent appropriate crankshaft angle determined in step 136. This provides the advantage that the injected fuel will be in contact with a cold intake manifold or combustion chamber for a shorter period of time, therefore less of the injected fuel will condense on the interior surfaces of the intake manifold or combustion chamber. This may improve engine start-up emissions because less fuel may need to be injected in order to provide a sufficient quantity of vaporized fuel to support combustion. Before the engine speed reaches the running threshold, the subsequent injection event may be a cranking injection event that provides a richer A/F mixture during the engine start-up period. After the engine speed reaches the running threshold, the subsequent injection event may be a running injection event initiation of the running injection events may be based mainly on desired engine power output. Following the engine start-up period, the running injection events may also be based on estimated fuel temperature.

According to method 100, following step 138, INITIATE THE SUBSEQUENT INJECTION EVENT AT THE SUBSEQUENT APPROPRIATE CRANKSHAFT ANGLE, the controller 18 may proceed to step 140, DETERMINE IF ENGINE TEMPERATURE IS GREATER THAN ENGINE TEMPERATURE THRESHOLD. At Step 140 the controller 18 may determine if engine temperature is greater than engine temperature threshold. As illustrated in FIG. 2, if the engine temperature is less than the engine temperature threshold, the controller 18 may return to step 132, DETERMINE A SUBSEQUENT HEATER TEMPERATURE AFTER A PRECEDING INJECTION EVENT. The controller 18 may continue to loop through steps 132 through 140 to continue to base the subsequent injection events on the estimated fuel temperature until the engine temperature is greater than the engine temperature threshold. Otherwise, if the engine temperature is greater than the engine temperature threshold, the controller 18 may proceed to step 142, DETERMINE IF INJECTOR HEATER OPERATION TIME HAS ELAPSED.

According to method 100, at step 142 the controller 18 may determine if the injector heater operation time has elapsed, for example the heater operation time may be 20 seconds. As illustrated in FIG. 2, if the injector heater operation time has not elapsed, the controller 18 may return to step 132, DETERMINE A SUBSEQUENT HEATER TEMPERATURE AFTER A PRECEDING INJECTION EVENT. The controller 18 may continue to loop through steps 132 through 142 to continue to base the subsequent injection events on the estimated fuel temperature until the injector heater operation time has elapsed. Otherwise, if the injector heater time has elapsed, the controller 18 may advance to step 144, DEACTIVATE INJECTOR HEATERS. At step 144, the controller 18 may terminate the supply of electrical power to the injector heater element 20.

According to method 100, following step 144 the controller 18 may proceed to step 146, DETERMINE IF SUBSEQUENT INJECTION EVENT BASED ON THE SUBSEQUENT FUEL TEMPERATURE. At step 146 the controller 18 may determine if the subsequent injection event is based on the subsequent fuel temperature. If the controller 18 determines that the subsequent injection event is based on the subsequent fuel temperature, the controller 18 may return to step 132, DETERMINE A SUBSEQUENT HEATER TEMPERATURE AFTER A PRECEDING INJECTION EVENT. The controller 18 may continue to loop through steps 132 through 146 to continue to base the subsequent injection events on the estimated fuel temperature until it is determined that subsequent injection events are not based on fuel temperature. Else, if the subsequent injection event is not based on the subsequent fuel temperature, the controller 18 may go to step 120, INITIATE RUN INJECTION EVENT AT APPROPRIATE CRANKSHAFT ANGLES, wherein the initiation of the running injection events are based mainly on desired engine power output and not on an estimated fuel temperature.

FIG. 3 illustrates additional steps that may be included in method 100. According to method 100, after step 124, DETERMINE INJECTOR HEATER TEMPERATURE and step 126, ESTIMATE A FUEL TEMPERATURE OF THE FUEL WITHIN THE FUEL INJECTOR BASED ON THE HEATER TEMPERATURE, the method 100 may further include step 148, DETERMINE IF THE FUEL TEMPERATURE EXCEEDS A PRIMING TEMPERATURE THRESHOLD. At step 148 the controller 18 may determine if the fuel temperature exceeds a priming temperature threshold, for example 145° C. If the fuel temperature does not exceed the priming temperature threshold, the controller 18 may continue to step 150, DELAY THE PRIMING INJECTION EVENT. At step 150 the controller 18 may delay the priming injection event for a set time period, for example 2 seconds and then the controller 18 may return to step 124, DETERMINE INJECTOR HEATER TEMPERATURE. The controller 18 may continue to loop through steps 150, 124, 126, and 148 until the fuel temperature exceeds the priming temperature threshold. Delaying the priming injection event until the fuel temperature exceeds the priming temperature threshold may provide the benefit of preventing fuel that is not heated enough to vaporize sufficiently to support combustion from being injected into the engine. Otherwise, if the fuel temperature exceeds the priming temperature threshold, controller 18 may continue to step 152, DETERMINE IF THE FUEL TEMPERATURE EXCEEDS THE PRIMING TEMPERATURE THRESHOLD FOR TIME INTERVAL.

According to method 100, at step 152 the controller 18 may determine if the fuel temperature has exceeded the temperature threshold for a preset time interval. If the fuel temperature has not exceeded the temperature threshold for the preset time interval, the controller 18 may advance to step 154, DELAY THE PRIMING INJECTION EVENT. At Step 154 the controller 18 may delay the priming injection event for a set time period, for example 2 seconds, and then the controller 18 may return to step 124, DETERMINE INJECTOR HEATER TEMPERATURE. The controller 18 may continue to loop through steps 154, 124, 126, 148, and 152 until the fuel temperature exceeds the temperature threshold for the preset time interval. Delaying the priming injection event until the fuel temperature exceeds the priming temperature threshold for a preset time interval may provide the benefit of preventing fuel that is not heated enough to vaporize sufficiently to support combustion from being injected into the engine because the injector heater element 20 has not yet sufficiently heated the heated fuel injector 16 in order to heat the fuel to the desired fuel temperature. If the fuel temperature has exceeded the priming temperature threshold for the preset time interval, according to method 100 the controller 18 may continue to step 130, INITIATE THE PRIMING INJECTION EVENT AT THE APPROPRIATE CRANKSHAFT ANGLE.

Following step 130, INITIATE THE PRIMING INJECTION EVENT AT THE APPROPRIATE CRANKSHAFT ANGLE, the method 100 may further include step 156, DETERMINE A PRIMING INJECTION DURATION BASED ON THE FUEL TEMPERATURE and step 158, OPERATE THE FUEL INJECTOR FOR THE PRIMING INJECTION DURATION. At step 156, the controller 18 may determine the priming injection duration, that is, the length of time that the controller 18 will command the heated fuel injector 16 to deliver fuel to the engine. At step 158, the controller 18 may operate the heated fuel injector 16, as a non-limiting example by supplying electrical power to the solenoid of the heated fuel injector 16 to open valve in the heated fuel injector 16, for a period of time calculated by the controller 18 in step 156. The priming injection duration is usually much longer than the subsequent cranking injection duration and running injection duration. The priming injection duration delivers a quantity of fuel, not only to fire the engine, but to also provide a “reservoir” of fuel, by wetting down the interior surfaces of the intake manifold, sufficient to produce a flawless crank-to-run transition without any engine stumbling or hesitations. In addition to fuel temperature, the priming injection duration may be a function of the ambient air temperature. The priming injection duration may also be a function of electrical system voltage to account for effects of the electrical voltage applied to the solenoid valve on solenoid valve opening times. At the temperature at which the fuel is heated by the heated fuel injector 16, less fuel may need to be injected into the engine to provide a sufficient quality of vaporized fuel to support combustion. Therefore step 130 may provide the benefit allowing cold start-up, for example at ambient temperatures at or below −5° C. with lower volatility fuels, such as E-100 and reduced HC emissions by reducing unburned fuel being exhausted from the engine during engine start-up. According to method 100, Step 132, DETERMINE A SUBSEQUENT HEATER TEMPERATURE AFTER A PRECEDING INJECTION EVENT may follow step 158.

Following step 134, ESTIMATE A SUBSEQUENT FUEL TEMPERATURE OF THE FUEL WITHIN THE FUEL INJECTOR BASED ON THE SUBSEQUENT HEATER TEMPERATURE, the method 100 may further include step 160, DETERMINE IF SUBSEQUENT FUEL TEMPERATURE IS GREATER THAN SUBSEQUENT INJECTION EVENT TEMPERATURE THRESHOLD. At Step 160, the controller 18 may determine if the subsequent fuel temperature is greater than the subsequent injection event temperature threshold, for example 150° C. If the subsequent fuel temperature does not exceed the subsequent injection event temperature threshold, the method 100 advances to step 162, DELAY THE SUBSEQUENT INJECTION EVENT. At Step 162 the controller 18 may delay the subsequent injection event for a variable time period, for example the time required to complete 4 engine revolutions at the engine cranking speed, and then the controller 18 may return to step 132, DETERMINE A SUBSEQUENT HEATER TEMPERATURE AFTER A PRECEDING INJECTION EVENT to check the heater temperature following the delay. The controller 18 may continue to loop through steps 162, 132, 134, and 160 until the subsequent fuel temperature exceeds the subsequent injection event temperature threshold. Delaying the subsequent injection event until the fuel temperature exceeds the subsequent injection event temperature threshold may prevent fuel that is not heated enough to vaporize sufficiently to support combustion from being injected into the engine. The subsequent heater threshold may be greater than the heater threshold for the priming injection in step 148 because it may not be desirable for subsequent injection events to condense on the interior surfaces of the intake manifold or combustion chamber, therefore it may be desirable for the fuel delivered in subsequent injections to have a higher fuel temperature than the priming injection to make fuel condensation less likely.

If the subsequent fuel temperature exceeds the subsequent injection event temperature threshold, the method 100 may proceed to step 138, INITIATE THE SUBSEQUENT INJECTION EVENT AT THE SUBSEQUENT APPROPRIATE CRANKSHAFT ANGLE.

Following step 138, INITIATE THE SUBSEQUENT INJECTION EVENT AT THE SUBSEQUENT APPROPRIATE CRANKSHAFT ANGLE the method 100 may further include the step 164, DETERMINE SUBSEQUENT INJECTION DURATION BASED ON THE FUEL TEMPERATURE and step 166 OPERATE THE FUEL INJECTOR FOR THE SUBSEQUENT INJECTION DURATION. At step 164, the controller 18 may determine the subsequent injection duration, that is, the length of time that the controller 18 will command the heated fuel injector 16 to deliver fuel to the engine. At step 166, the controller 18 may operate the heated fuel injector 16, as a non-limiting example, by supplying electrical power to the solenoid of the heated fuel injector 16 to open the fuel injector valve, for a period of time calculated by the controller 18 in step 164. When the engine speed is slower than the engine running threshold, the subsequent injection duration may be cranking injection duration. Cranking injection duration is generally determined by the controller 18 based on fuel temperature, electrical system voltage, ambient air temperature, engine temperature, and the number of cranking injection events. Typically the cranking injection duration deceases as the number of cranking injection events during the engine start-up period increases. Cranking injection duration is intended to produce the proper in-cylinder vapor concentration required to initiate and sustain cold-engine combustion. When the engine speed exceeds the engine running threshold, the subsequent injection duration may be running injection duration. Running injection duration is typically based on desired engine output; however it may additionally be based on fuel temperature, electrical system voltage, ambient air temperature, and engine temperature. Following step 166, the controller may return to step 140 DETERMINE IF ENGINE TEMPERATURE IS GREATER THAN ENGINE TEMPERATURE THRESHOLD according to method 100.

Accordingly, a system 10, a controller 18, and a method 100 for controlling a fuel-injected internal combustion engine 12 having a heated fuel injector 16 during engine start-up are provided. A system 10 with a controller 18 operating according to the steps of method 100 may provide the benefits of improved cold starting due to improved vaporization of lower volatility liquid fuels, such as ethanol, and reduced carbon monoxide and hydrocarbon emissions during engine start-up because a leaner air to fuel ratio may be used, especially with lower volatility fuels. The controller 18 may determine a fuel temperature and adjust the amount of fuel injected into the engine by determining injection duration based on an estimated fuel temperature. The controller 18 may also adjust the initiation of an injection event relative a crankshaft angle so that the injection event is timed to limit condensation of fuel on the interior surfaces of the intake manifold or the combustion chamber.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

We claim:

1. A method of controlling a fuel injector during start-up of a fuel injected internal combustion engine, said fuel injector having a heater element configured to heat fuel within the fuel injector and indicate heater temperature, said method comprising the steps of:
estimating a fuel temperature of the fuel within the fuel injector based on the heater temperature;
determining a crankshaft angle to initiate a priming injection event based on the fuel temperature; and
initiating the priming injection event at the crankshaft angle.

2. The method of claim 1, further comprising the steps of:
determining if the fuel temperature exceeds a priming temperature threshold; and
delaying the priming injection event until the fuel temperature exceeds the priming temperature threshold.

3. The method of claim 2, wherein the method further comprises the step of:
delaying the priming injection event until the fuel temperature exceeds the priming temperature threshold for a predetermined time interval.

4. The method of claim 1, wherein the method further comprises the steps of:
determining a priming injection duration based on the fuel temperature; and
operating the fuel injector for the priming injection duration.

5. The method of claim 1, wherein the method further comprises the steps of:
determining a subsequent heater temperature after a preceding injection event;
estimating a subsequent fuel temperature of the fuel within the fuel injector based on the subsequent heater temperature;
determining a subsequent crankshaft angle to initiate a subsequent injection event based on the subsequent fuel temperature; and
initiating the subsequent injection event at the subsequent crankshaft angle.

6. The method of claim 5, further comprising the steps of:
determining if the subsequent fuel temperature exceeds a subsequent injection event temperature threshold; and
delaying the subsequent injection event until the subsequent fuel temperature exceeds the subsequent injection event temperature threshold.

7. The method of claim 5, wherein the subsequent injection event is a cranking injection event.

8. The method of claim 5, wherein the subsequent injection event is a running injection event.

9. The method of claim 5, wherein the step of estimating the subsequent fuel temperature includes determining at least one other engine operating parameter selected from a group consisting of manifold air temperature, fuel mass rate, heater element activation start time, and heater element activation elapsed time.

10. The method of claim 5, wherein the method further comprises the steps of:
determining a subsequent injection duration based on the subsequent fuel temperature; and
operating the fuel injector for the subsequent injection duration.

11. The method of claim 10, wherein the subsequent injection duration is a cranking injection duration.

12. The method of claim 10, wherein the subsequent injection duration is a running injection duration.

13. The method of claim 10, wherein the subsequent injection duration is based on at least one other engine operating parameter selected from a group consisting of system voltage, ambient temperature, engine temperature, and cranking duration.

14. The method of claim 1, wherein the step of estimating the fuel temperature is based on at least one other engine operating parameter selected from a group consisting of manifold air temperature, fuel mass rate, heater element activation start time, and heater element activation elapsed time.

15. A system configured to control a fuel-injected internal combustion engine during engine start-up, said system comprising:
A heated fuel injector; and
a controller configured to operate the heated fuel injector according to the method of claim 1.

16. A controller configured to operate a heated fuel injector according to the method of claim 1.
